(19) United States
(12) Patent Application Publication
(10) Pub. No.: US 2025/0088958 A1
(43) Pub. Date: Mar. 13, 2025

(54) METHOD AND APPARATUS FOR ENERGY EFFICIENT ACCESS POINT IN WIRELESS COMMUNICATION SYSTEM

(71) Applicant: Samsung Electronics Co., Ltd., Gyeonggi-do (KR)

(72) Inventors: Yongsen MA, Milpitas, CA (US); Michail KOUNDOURAKIS, Hamburg (DE); Mark Gorthorn RISON, Cambridge (GB); Srinivas KANDALA, Morgan Hill, CA (US); Ravi GIDVANI, Fremont, CA (US)

(21) Appl. No.: 18/819,413

(22) Filed: Aug. 29, 2024

Related U.S. Application Data
(60) Provisional application No. 63/537,730, filed on Sep. 11, 2023.
(60) Provisional application No. 63/591,244, filed on Oct. 18, 2023.
(60) Provisional application No. 63/621,205, filed on Jan. 16, 2024.
(60) Provisional application No. 63/564,286, filed on Mar. 12, 2024.

(51) Int. Cl. H04W 52/02

(52) U.S. Cl. CPC H04W 52/0206

(57) ABSTRACT

A system and a method are disclosed for implementing power saving protocols for devices in a wireless communication system. A method performed by an AP is provided, which includes transmitting, to a STA, a first message indicating a power save schedule of the AP; and transitioning, during a scheduled time window, from an awake state to a reduced power state, based on the power save schedule. The reduced power state is associated with a power state transition capability.

### CROSS-REFERENCE TO RELATED APPLICATION

This application claims the priority benefit under 35 U.S.C. § 119 (e) of U.S. Provisional Application Nos. 63/537,730, 63/591,244, 63/621,205, and 63/564,286, which were filed on Sep. 11, 2023, Oct. 18, 2023, Jan. 16, 2024, and Mar. 12, 2024, respectively, the disclosure of each of which is incorporated by reference in its entirety as if fully set forth herein.

### TECHNICAL FIELD

The disclosure generally relates to power saving protocols for devices in a wireless communication system. More particularly, the subject matter disclosed herein relates to improving energy efficiency of an access point (AP) through balancing power saving and performance requirements using AP schedule and/or capability adjustments.

### SUMMARY

The number of wireless local area network (WLAN) devices has been steadily growing in recent years because of the increasing demand of wireless data and applications and the high performance and easy deployment of WLAN protocols.

Requirements and recommendations are currently being proposed from standard development organizations, e.g., Institute of Electrical and Electronics Engineers (IEEE), to improve energy efficiency of APs for sustainability purposes, such as meeting net zero and carbon neutral goals.

Existing power saving protocols have been designed mostly for non-AP stations (STAs), but do not focus on APs.

Wi-Fi Alliance (WFA) has defined a notice of absence (NoA) for power saving for a peer-to-peer group owner (P2P GO) in Wi-Fi Direct. Additionally, a power management mode has been provided for a personal basic service set (PBSS) control point in a PBSS. However, even if these types of power saving approaches can be adopted for IEEE 802.11 APs, they would introduce functionality and performance degradation for both APs and non-AP STAs. For example, both of these approaches would not work for legacy devices, on-demand data, or any devices that do not know an AP's doze status.

Accordingly, an aspect of present disclosure is to provide protocols and options to improve the energy efficiency of APs while limiting negative impact.

Accordingly, another aspect of the present disclosure is to provide protocols and options protocols and options for APs to balance power saving and performance requirements by adjusting an AP's schedule and capability.

In accordance with another aspect of the present disclosure, an AP may be absent for certain time periods using an absence notification. For example, this allows an AP to reduce power/energy consumption in certain scenarios, e.g., when there is a small number of associated clients or low volume of data traffic.

In accordance with another aspect of the present disclosure, to meet requirements of legacy devices and on-demand data while staying in power saving mode, an AP may periodically switch to a listen state and choose to respond to legacy devices or on-demand data in deferred or immediate manners.

In accordance with another aspect of the present disclosure, an AP may remain in a reduced capability mode, such as operating with a single antenna, reduced bandwidth, lower modulation coding scheme (MCS), etc., during a scheduled time window.

In accordance with another aspect of the present disclosure, non-AP STAs can send a presence request or action frame to influence power saving scheduling of an AP.

In an embodiment, a method is provided for an AP. The method includes transmitting, to a STA, a first message indicating a power save schedule of the AP; and transitioning, during a scheduled time window, from an awake state to a reduced power state, based on the power save schedule. The reduced power state is associated with a power state transition capability.

In an embodiment, an AP is provided, which includes a transceiver; and a processor configured to transmit, to a STA, via the transceiver, a first message indicating a power save schedule of the AP, and transition the AP, during a scheduled time window, from an awake state to a reduced power state, based on the power save schedule. The reduced power state is associated with a power state transition capability.

### BRIEF DESCRIPTION OF THE DRAWING

In the following section, the aspects of the subject matter disclosed herein will be described with reference to exemplary embodiments illustrated in the figures, in which:

FIG. 1 illustrates an example of scheduled AP power management, according to an embodiment;

FIG. 2 illustrates a table comparing characteristics of an AP in different power states and power management modes, according to an embodiment;

FIG. 3 illustrates an example of an AP specifying a power save schedule utilizing an absence notification, according to an embodiment;

FIG. 4 illustrates an example of an AP stopping and resuming a power save schedule, according to an embodiment;

FIG. 5 illustrates examples of an AP operating in a listen state, according to an embodiment;

FIG. 6A is a flow chart illustrating a method performed by an AP, according to an embodiment;

FIG. 6B is a flow chart illustrating a method performed by an AP, according to an embodiment;

FIG. 7 is a block diagram of an electronic device in a network environment, according to an embodiment; and

FIG. 8 shows a system including an AP and an STA in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

In accordance with an embodiment of the disclosure, protocols and operations are provided for absence notification, and power state transition capability and schedule management, which allow for power saving by an AP while being able to adapt to different network conditions/requirements, power saving requirements, and tolerance of functional and performance degradation.

More specifically, the disclosure provides:
power saving for an AP while limiting negative impact, such as issues regarding connectivity, performance, quality of service, fairness, etc.
options to have trade-off and balance between power saving and performance requirements.
an absence notification allowing an AP to be absent for certain time periods, which provides power saving for the AP.
capability options allowing an AP to respond to legacy devices and on-demand data, such as probe request and latency sensitive data, with different urgency requirements.
provides scheduling options allowing an AP and/or a STA to interrupt, update, request, report, adjust, feedback, etc., the schedule in different scenarios such as different network conditions/requirements, power saving requirements, and tolerance of functional & performance degradation.
options for an AP and an STA to have negotiation/agreement about a power save mode/level/schedule.

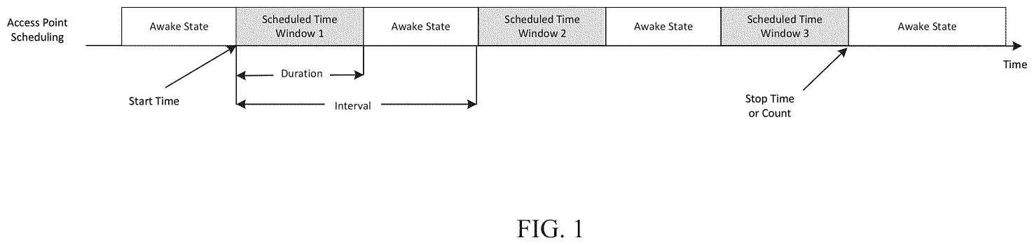

FIG. 1 illustrates an example of scheduled AP power management, according to an embodiment. More specifically, FIG. 1 illustrates an example of a schedule during which the AP may be in different power states with different capabilities.

Referring to FIG. 1, the AP stays in an active mode (i.e., an awake state) outside of scheduled time windows. In the awake state, the AP may transmit and receive frames at any time.

In the scheduled time windows, the AP can be in different power states, such as a doze state, a listen state, or an awake state with reduced capability (or a reduced capability awake state). For example, in scheduled time window 1 the AP may be in the doze state, in scheduled time window 2 the AP may be in the listen state, and in scheduled time window 3 the AP may be in the awake state with reduced capability.

In the doze state, the AP turns off the radio and does not transmit, receive, or update a buffer.

In the listen state, the AP does not transmit, but may perform clear channel assessment (CCA) or detect a presence of wireless signals. Compared with the doze state, an AP in the listen state may have less power saving, but introduces less functional and performance degradation. For example, an AP in the listen state may respond to on-demand data and change the schedule a later time, e.g., after a scheduled time window, or exit a power save mode early and respond to the on-demand data immediately.

In the awake state with reduced capability, the AP remains in the awake state but with reduced capability, e.g., uses a single antenna, reduced bandwidth, lower MCS, etc.

The AP may also have different power state transition capabilities during the scheduled time windows. A power state transition capability may be set for a specific scheduled time window or windows or may be applicable for a whole schedule.

In a scheduled time window for the doze state, the AP may or may not have the capability to wake up. When the AP cannot wake up during the scheduled time window for the doze state, the AP remains in the doze state for the entire scheduled time window and can only wake up and enter the awake state after the scheduled time window expires.

When the AP can wake up during the scheduled time window for the doze state, the AP may wake up and enter the awake state based on certain signals, e.g., wake up radio (WUR) and/or multi-link operations (MLO).

In a scheduled time window for the listen state, the AP may or may not have the capability to transmit, i.e., the capability to interrupt the listen state before the end of the scheduled time window. When the AP cannot transmit during the scheduled time window for the listen state, the AP remains in the listen state for the entire scheduled time window and cannot switch to a transmit state until the scheduled time window expires. However, the AP may switch to a receive state in order to update the buffer prior to the scheduled time window expiring.

When the AP can transmit during the scheduled time window for the listen state, the AP may switch to the receive state for on-demand data, e.g., a probe request or latency sensitive data. That is, in response to the probe request or latency sensitive data during the scheduled time window for the listen state, the AP may exit the listen state and switch to the transmit state to respond.

In a scheduled time window for the awake state with reduced capability, the AP may or may not have the capability to switch to a transmit, receive, or listen state with full capability. When the AP cannot switch to a transmit, receive, or listen state with full capability in the scheduled time window for the awake state with reduced capability, the AP may switch to a transmit, receive, or listen state with partial capability, e.g., single-input, single-output (SISO) or a non-high throughput (HT) mode, before the scheduled time window expires.

When the AP can switch to a transmit, receive, or listen state with full capability in the scheduled time window for the awake state with reduced capability, the AP may switch to a transmit, receive, or listen state with full capability, i.e., the awake state, before the scheduled time window expires.

Outside of a scheduled time window, i.e., in the awake state, the AP may freely switch between transmit, receive, and listen states, and may receive and transmit frames at any time.

The AP may use different schedule parameters such as start time, stop time, duration, interval, count, power state, power state transition capability, etc., to indicate a schedule and balance power saving and performance requirements. For example, the AP May reuse existing information elements (IEs) such as a schedule element and/or existing functions such as target wake time (TWT). Additionally, scheduling information may be transmitted in separate IEs or a single IE.

The AP may change a schedule based on network conditions, traffic volume, requirements of power saving, functionality and performance, etc.

Non-AP STAs may indicate their presence information, e.g., send a presence request, using a probe request or an action frame to influence an AP schedule in terms of a single scheduled time window, all the scheduled time window(s) of a schedule instance, or multiple schedule instances. Non-AP STAs may also send a schedule request to obtain the most recent schedule and capability information from the AP.

According to an embodiment, an AP may use absence notification to inform STAs of the scheduled time windows. For example, the AP may determine to be absent (e.g., in a doze state) for certain time periods in certain scenarios, e.g., when there is a small number of associated clients or low volume of data traffic. That is, the AP may use absence notification and go into a power save mode transitioning between an awake state and a doze state. Absence notification can be published by AP in beacon and/or action frames.

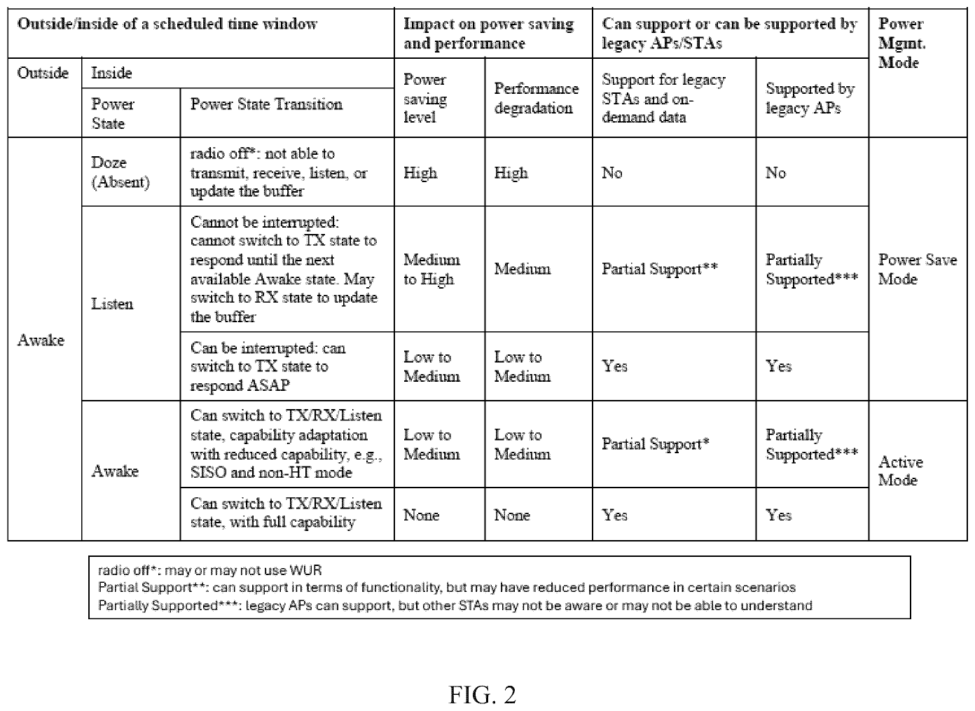

FIG. 2 illustrates a table comparing characteristics of an AP in different power states and power management modes, according to an embodiment.

Referring to FIG. 2, among the characteristics, the table illustrates the tradeoff between power level savings and performance degradation in the different power states with different power state transition capabilities.

More specifically, when operating outside of a scheduled time window, the AP is an awake state, e.g., as illustrated in FIG. 1.

When operating inside of a scheduled time window, the AP may be in a doze (or absent) state, a listen state, or an awake state with reduce capability. Further, inside of a scheduled time window, in the listen state and the awake with reduce capability state, the AP may have different power state transition capabilities. That is, in the listen state, the AP may or may have the capability to interrupt the listen state, e.g., switch to a transmit state before expiration of the scheduled time window. Further, in the awake state with reduced capability, the AP may may or may not have the capability to switch to a transmit, receive, or listen state with full capability.

As illustrated in the table, the AP in the doze state has high power saving, but at a tradeoff of high performance degradation.

The AP in the listen state, without the capability to interrupt the listen state, has medium to high power saving with medium performance degradation. The AP in the listen state, with the capability to interrupt the listen state, has low to medium power saving with low to medium performance degradation.

The AP in the awake state with reduced capability, without the capability to switch to a transmit, receive, or listen state with full capability, has low to medium power saving with low to medium performance degradation. The AP in the awake state with reduced capability, with the capability to switch to a transmit, receive, or listen state with full capability, has no power saving and no performance degradation, as it essentially operates in the awake mode.

Additionally, the table illustrates the support levels for legacy STAs and on-demand data, as well as by legacy APs, for the different power states.

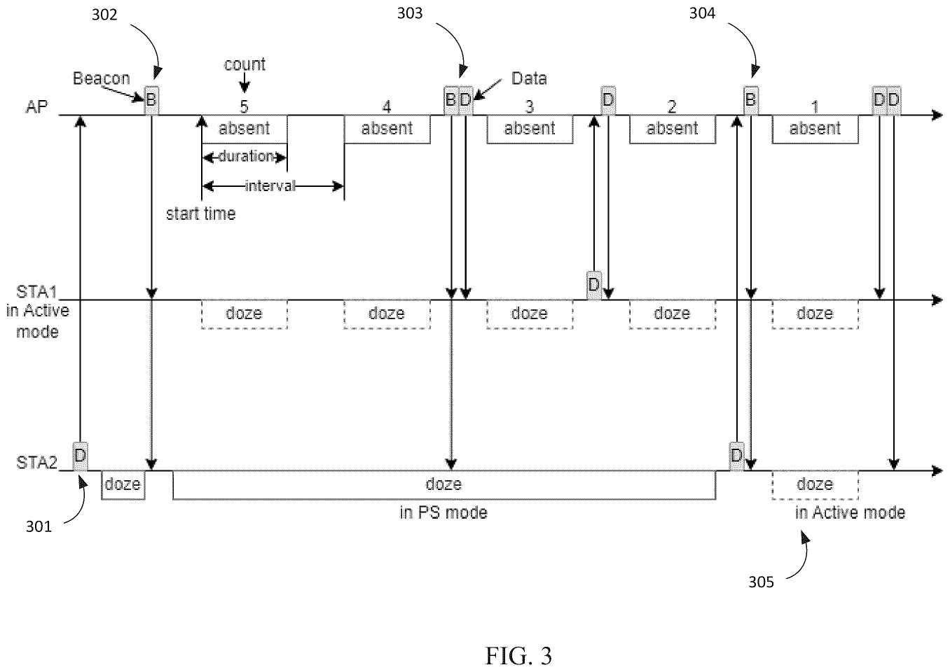

FIG. 3 illustrates an example of an AP specifying a power save schedule utilizing an absence notification, according to an embodiment.

Referring to FIG. 3, an AP is communicating with an STA1 that is operating in an active mode and an STA2 that is operating in a power save mode, which it transitions between a doze state and an active state. Although FIG. 3 illustrates an example in which the AP is communicating with two STAs, the disclosure is not limited to this example, and the AP may communicate with more than two STAs.

At 301 STA2 transmits data to the AP.

At 302, the AP transmits a beacon to STAs 1 and 2. The AP can specify a power save schedule and send absence notification in the beacon. Alternatively, the AP can specify the power save schedule and send absence notification in a probe response or an action frame.

In the example of FIG. 3, the power save schedule and absence notification provide schedule parameters including a start time, a duration, an interval, and a count.

After receiving and decoding the beacon, STA1, which is operating in an active mode, may transition to a doze state, corresponding to when the AP is absent, based on the power save schedule. Since STA2 is already operating in a power save mode, it may enter into the doze state according to its power save mode settings.

At 303 and 304, during awake states between the absent intervals at counts 4 and 3 and counts 2 and 1, respectively, the AP transmits a beacon to STAs 1 and 2, which may resend the previous power save schedule and absence notification or may specify a change to the power save schedule and absence notification. The AP may also send data to STA1 and/or STA2 when in the active mode.

At 305, STA2, now operating in active mode, after receiving and decoding the beacon, may also transition to a doze state, corresponding to when the AP is absent, based on the power save schedule.

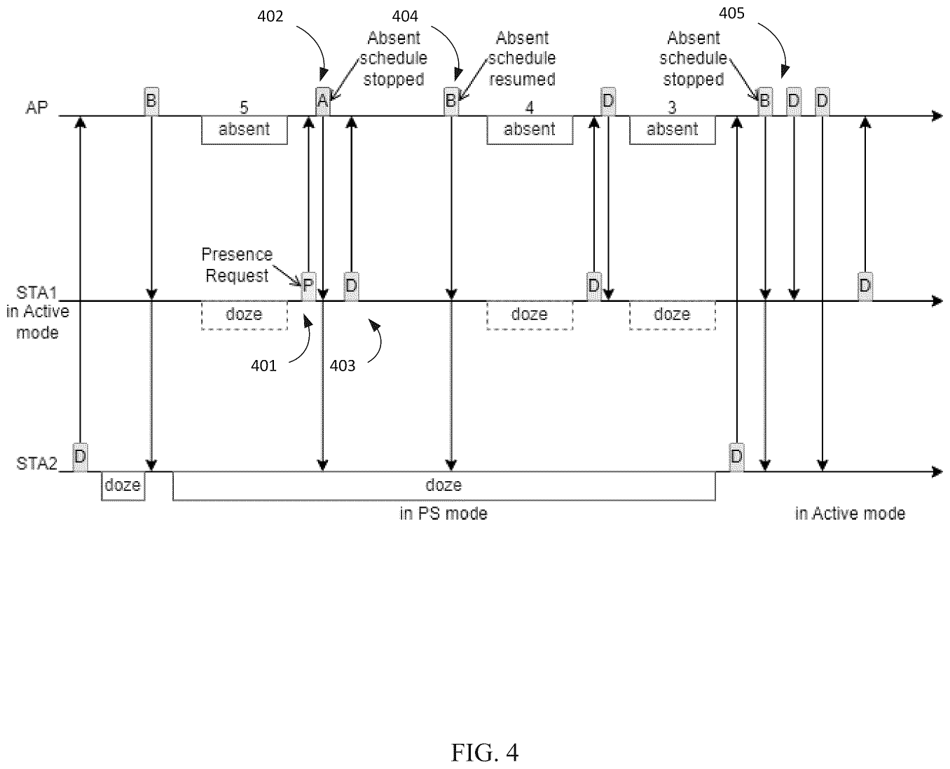

FIG. 4 illustrates an example of an AP stopping and resuming a power save schedule, according to an embodiment.

Referring to FIG. 4, an AP is communicating with an STA1 that is operating in an active mode and an STA2 that is operating in a power save mode, which it transitions between a doze state and an active state. Although FIG. 4 illustrates an example in which the AP is communicating with two STAs, the disclosure is not limited to this example, and the AP may communicate with more than two STAs.

Similar to FIG. 3 as described above, the AP transmits a beacon to STAs 1 and 2. The AP can specify a power save schedule and send absence notification in the beacon. Alternatively, the AP can specify the power save schedule and send absence notification in a probe response or an action frame.

After receiving and decoding the beacon, STA1, which is operating in an active mode, may transition to a doze state, corresponding to when the AP is absent, based on the power save schedule. Since STA2 is already operating in a power save mode, it may enter into the doze state according to its power save mode settings.

At 401, STA1 transmits a presence request to the AP in an awake state.

At 402, in response the presence request, the AP transmits a response frame to STA1 and STA2, indicating that the power save schedule is being stopped, and that the AP will remain in the awake state.

At 403, STA1 may transmit data to the AP, as it does not switch to an absent (doze) state.

At 404, the AP transmits another beacon to STAs 1 and 2. The beacon can indicate resumption of the previous power save schedule or a new power save schedule.

At 405, during an awake state, the AP transmits another beacon to STAs 1 and 2. The beacon indicates that the power save schedule is being stopped, and that the AP will remain in the awake state.

Thereafter, the AP and STAs 1 and 2 may transmit and receive data.

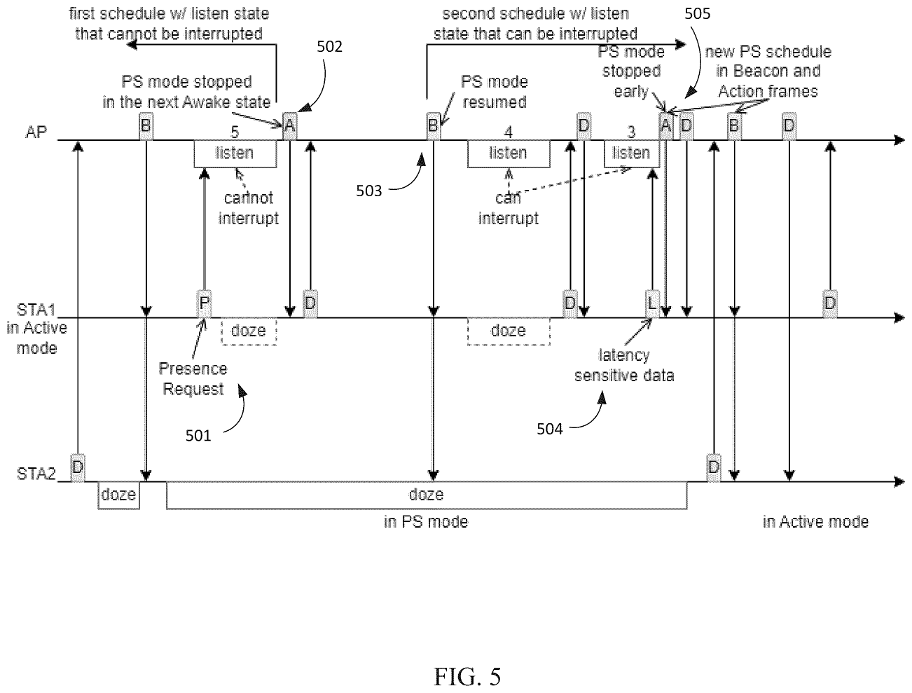

FIG. 5 illustrates examples of an AP operating in a listen state, according to an embodiment.

Referring to FIG. 5, an AP is communicating with an STA1 that is operating in an active mode and an STA2 that is operating in a power save mode, which it transitions between a doze state and an active state. Although FIG. 5 illustrates an example in which the AP is communicating with two STAs, the disclosure is not limited to this example, and the AP may communicate with more than two STAs.

Similar to FIGS. 3 and 4 as described above, the AP transmits a beacon to STAs 1 and 2. The AP can specify a power save schedule and send absence notification in the beacon. Alternatively, the AP can specify the power save schedule and send absence notification in a probe response or an action frame.

Different from FIGS. 3 and 4, instead of scheduling doze states, the power save schedule and absence notification indicate a listen state that cannot be interrupted, during which the AP does not transmit, but may perform CCA or detect a presence of wireless signals from the STAs 1 and 2. Compared with the doze state, an AP in the listen state may have less power saving, but introduces less functional and performance degradation.

After receiving and decoding the beacon, STA1, which is operating in an active mode, may transition to a doze state, corresponding to when the AP is in the listen state, based on the power save schedule. Since STA2 is already operating in a power save mode, it may enter into the doze state according to its power save mode settings.

As described above, in a scheduled time window for the listen state, the AP may or may not have the capability to transmit. When the AP cannot transmit during the scheduled time window for the listen state, the AP remains in the listen state for the entire scheduled time window and cannot switch to a transmit state until the scheduled time window expires. However, the AP may switch to a receive state in order to update the buffer prior to the scheduled time window expiring.

More specifically, at 501, STA1 transmits a presence request to the AP in the listen state. Here, because the AP does not have the capability to interrupt and transmit, it remains in the listen state for the entire scheduled time window and switches to a transmit state after the scheduled time window expires.

Additionally, because the AP does not have the capability to interrupt and transmit, STA1 may also switch to a doze state for the remainder of the listening state interval.

At 502, the AP transmits an announcement frame to STA1, indicating that the power save schedule (i.e., next scheduled listen state) is being stopped, and that the AP will remain in the awake state. Although FIG. 5 illustrates an announcement frame being transmitted to STA1, the disclosure is not limited thereto. For example, the AP may send an indication using an action frame or some other type of frame such as control, management, and/or data frames.

Thereafter, STA1 can transmit data to the AP.

At 503, the AP transmits another beacon to STAs 1 and 2. The AP specifies another power save schedule and sends absence notification in the beacon. Alternatively, the AP can specify the power save schedule and send absence notification in a probe response or an action frame. Different from the previous beacon, the power save schedule and absence notification indicate a listen state that can be interrupted.

At 504, upon determining latency sensitive (or on-demand) data, STA1 transmits an indication of the data to the AP in the listen state. For example, STA1 may transmit an indication that is has the latency sensitive data in order for the AP to wake up to receive the data, or the STA1 may simply transmitting the data in order for the AP to wake up. Because the AP is in a listen state that can be interrupted, the AP may switch to the receive state for on-demand data. That is, in response to the latency sensitive data during the scheduled time window for the listen state, the AP may exit the listen state and switch to the transmit state to respond.

Additionally, because the AP has the capability to interrupt and transmit, STA1 does not switch to a doze state for the remainder of the listening state interval, as STA1 expects the AP to transmit.

At 505, in response to receiving indication of the data, the AP transmits a response frame (or an announcement frame) to STA1, indicating that the power save schedule (i.e., the current listen state) is being stopped early, and that the AP will switch to the awake state. Thereafter, the AP and STA1 can transmit and receive data.

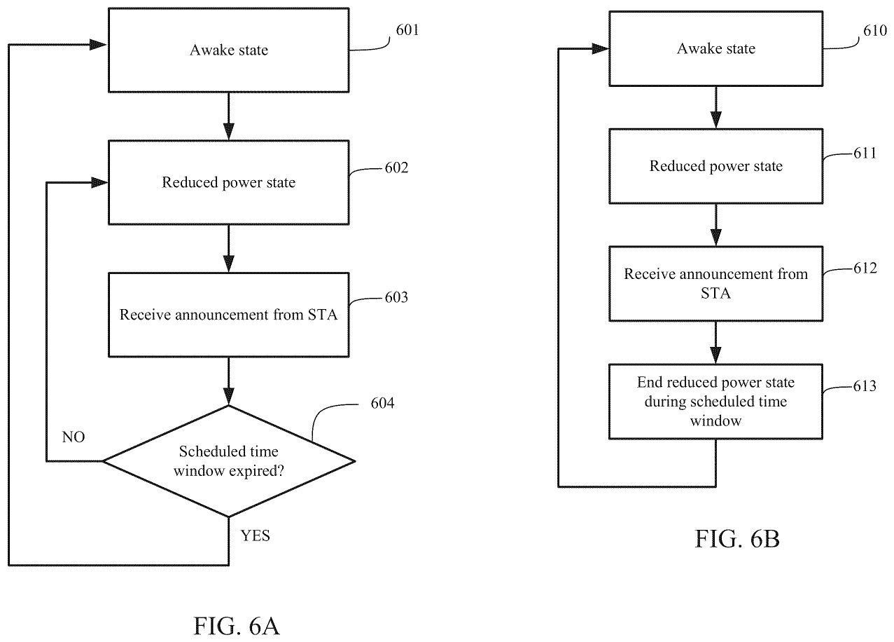

FIG. 6A is a flow chart illustrating a method performed by an AP, according to an embodiment. More specifically, FIG. 6A illustrates AP operations when a reduced power state is associated with a power state transition capability that does not allow the AP to transition prior to the expiration of a scheduled time window of the reduced power state. For example, the operations in FIG. 6A may be performed by an AP when the reduced power state is a listen state and the associated power state transition capability is that the listen state cannot be interrupted, or when the reduced power state is a reduced capability awake state, and the associated power state transition capability is that reduced capability awake state cannot be switched to the awake state with full capabilities.

Referring to FIG. 6A, in step 601, the AP operates in an awake state in which the AP can establish connects with one or more STAs, provide the STAs with a power save schedule of the AP, and transmit and receive data with the STAs.

In step 602, the AP transitions to a reduced power state, based on the power save schedule of the AP. For example, during a scheduled time window as illustrated in FIG. 1, the AP may transition to a reduced power state such as a listen state or an awake state with reduced capability.

In step 603, while in the reduced power state, the AP receives, from one of the STAs, a message, e.g., a presence request or an indication of latency sensitive data. Because the operations in FIG. 6A are performed with the power state transition capability that does not allow the AP to transition prior to the expiration of a scheduled time window of the reduced power state, the AP does not respond to the receive message while in the reduced power state. However, the AP may switch a reception state and buffer the received message.

In step 604, the AP determines if the scheduled time window. If the scheduled time window has not expired, the AP continues to operate in the reduced power state in step 602. However, if the scheduled time window has expired, the AP transitions from the reduced power state back to the awake state in step 601.

Once in the awake state, the AP may respond to the message received from the STA while in the reduced power state. For example, as illustrated at 502 in FIG. 5, the AP may transmit an announcement frame to STA1, indicating that the power save schedule (i.e., next scheduled listen state) is being stopped, and that the AP will remain in the awake state

FIG. 6B is a flow chart illustrating a method performed by an AP, according to an embodiment. More specifically, FIG. 6A illustrates AP operations when a reduced power state is associated with a power state transition capability that allows the AP to transition prior to the expiration of a scheduled time window of the reduced power state. For example, the operations in FIG. 6B may be performed by an AP when the reduced power state is a listen state and the associated power state transition capability is that the listen state can be interrupted, or when the reduced power state is a reduced capability awake state, and the associated power state transition capability is that the reduced capability awake state can be switched to the awake state with full capabilities.

Referring to FIG. 6B, in step 610, the AP operates in an awake state in which the AP can establish connects with one or more STAs, provide the STAs with a power save schedule of the AP, and transmit and receive data with the STAs.

In step 611, the AP transitions to a reduced power state, based on the power save schedule of the AP. For example, during a scheduled time window as illustrated in FIG. 1, the AP may transition to a reduced power state such as a listen state or an awake state with reduced capability.

In step 612, while in the reduced power state, the AP receives, from one of the STAs, a message, e.g., a presence request or an indication of latency sensitive data. Because the operations in FIG. 6B are performed with the power state transition capability that allows the AP to transition prior to the expiration of a scheduled time window of the reduced power state, the AP may respond to the receive message while in the reduced power state.

Accordingly, in response to the received message, the AP terminates the reduced power state during the scheduled time window in step 613, and transitions from the reduced power state back to the awake state in step 610.

Once in the awake state, the AP may respond to the message received from the STA. For example, as illustrated at 505 in FIG. 5, in response to receiving indication of the data, the AP transmits a response frame (or an announcement frame) to STA1, indicating that the power save schedule (i.e., the current listen state) is being stopped early, and that the AP will switch to the awake state.

In accordance with the above-described embodiments, scheduled AP power management may be used to adjust an AP's schedule and capability for AP power saving, absence notification may be used for an AP to be absent for certain time periods, which provides power saving for the AP, and a listen state with different power transition capabilities and an awake state with a reduced capability set are provided, allowing APs to respond to legacy devices and on-demand data, such as probe request and latency sensitive data, with different power saving requirements and urgency/performance requirements.

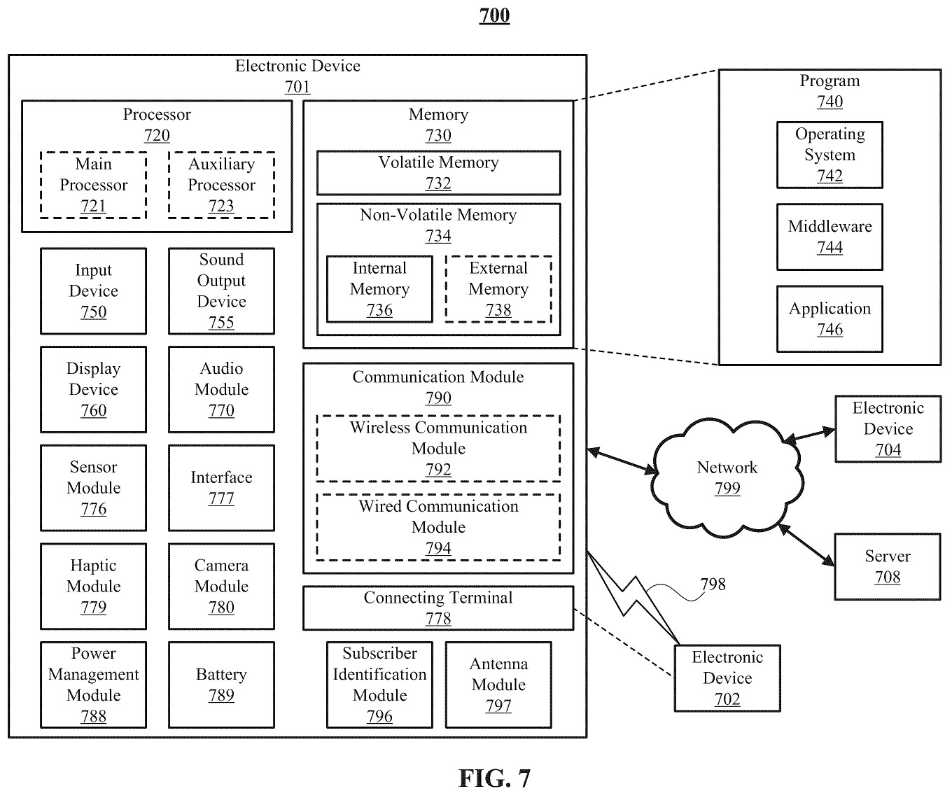

FIG. 7 is a block diagram of an electronic device in a network environment 700, according to an embodiment.

Referring to FIG. 7, an electronic device 701 (e.g., an AP or a non-AP STA) in a network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720, a memory 730, an input device 750, a sound output device 755, a display device 760, an audio module 770, a sensor module 776, an interface 777, a haptic module 779, a camera module 780, a power management module 788, a battery 789, a communication module 790, a subscriber identification module (SIM) card 796, or an antenna module 797. In one embodiment, at least one (e.g., the display device 760 or the camera module 780) of the components may be omitted from the electronic device 701, or one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled with the processor 720 and may perform various data processing or computations. For example, the processor 720 may execute software to control the electronic device 701 to perform the method illustrated in FIGS. 6A and 6B.

As at least part of the data processing or computations, the processor 720 may load a command or data received from another component (e.g., the sensor module 776 or the communication module 790) in volatile memory 732, process the command or the data stored in the volatile memory 732, and store resulting data in non-volatile memory 734. The processor 720 may include a main processor 721 (e.g., a central processing unit (CPU) or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734. Non-volatile memory 734 may include internal memory 736 and/or external memory 738.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. The display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. The audio module 770 may obtain the sound via the input device 750 or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device 702 directly (e.g., wired) or wirelessly. The interface 777 may include, for example, a high-definition multimedia interface (HDMI), a universal serial bus (USB) interface, a secure digital (SD) card interface, or an audio interface.

A connecting terminal 778 may include a connector via which the electronic device 701 may be physically connected with the external electronic device 702. The connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. The haptic module 779 may include, for example, a motor, a piezoelectric element, or an electrical stimulator.

The camera module 780 may capture a still image or moving images. The camera module 780 may include one or more lenses, image sensors, image signal processors, or flashes. The power management module 788 may manage power supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication. The communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as BLUETOOTH™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. The antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

Commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

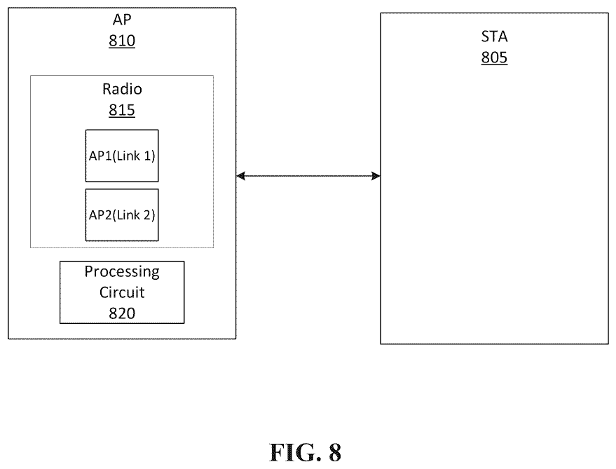

FIG. 8 shows a system including an STA 805 and an AP 810, in communication with each other. The AP 810 may include a radio 815 and a processing circuit (or a means for processing) 820, which may perform various methods disclosed herein, e.g., the method illustrated in FIGS. 6A and 6B. For example, the processing circuit 820 may receive, via the radio 815, transmissions from the STA 805, and the processing circuit 820 may transmit, via the radio 815, e.g., using one or multiple links, signals to STA 805.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by an access point (AP), the method comprising:
transmitting, to a station (STA), a first message indicating a power save schedule of the AP; and
transitioning, during a scheduled time window, from an awake state to a reduced power state, based on the power save schedule,
wherein the reduced power state is associated with a power state transition capability.

2. The method of claim 1, further comprising:
transitioning, after expiration of the scheduled time window, from the reduced power state to the awake state.

3. The method of claim 2, further comprising transmitting, to the STA, a second message indicating that the power save schedule is stopped.

4. The method of claim 2, further comprising:
after transitioning from the reduced power state to the awake state, receiving, from the STA, a second message;
modifying the power save schedule based on the second message; and
transmitting, to the STA, a third message indicating the modification of the power save schedule.

5. The method of claim 4, wherein the second message includes a presence request or an indication of latency sensitive data.

6. The method of claim 4, further comprising transmitting, to the STA, a fourth message indicating that the power save schedule is resumed.

7. The method of claim 6, wherein the fourth message includes a beacon.

8. The method of claim 4, wherein modifying the power save schedule comprises canceling a subsequent transition to the reduced power state scheduled to occur at a next scheduled time window.

9. The method of claim 1, wherein the reduced power state is a listen state in which the AP may receive signals from the STA but cannot transmit, and the associated power state transition capability is that the listen state cannot be interrupted.

10. The method of claim 9, further comprising:
receiving, from the STA, while in the listen state, a second message;
transitioning, after expiration of the scheduled time window, from the listen state to the awake state; and
transmitting, to the STA, a third message, in response to the second message.

11. The method of claim 10, wherein the second message includes a presence request or an indication of latency sensitive data, and
wherein the third message includes an active frame indicating that the power save schedule is stopped.

12. The method of claim 1, wherein the reduced power state is a listen state in which the AP may receive signals from the STA but cannot transmit, and the associated power state transition capability is that the listen state can be interrupted.

13. The method of claim 12, further comprising:
receiving, from the STA, while in the listen state, a second message;
transitioning, before expiration of the scheduled time window, from the listen state to the awake state; and
transmitting, to the STA, a third message, in response to the second message.

14. The method of claim 13, wherein the second message includes a presence request or an indication of latency sensitive data, and
wherein the third message includes an active frame indicating that the power save schedule is stopped.

15. The method of claim 1, wherein the first message includes a beacon.

16. The method of claim 1, wherein the power save schedule indicates a plurality of scheduled time windows, and
wherein the method further comprises repeatedly transitioning between the awake state and reduced power state in accordance with the plurality of scheduled time windows.

17. The method of claim 1, wherein the reduced power state is a reduced capability awake state, and the associated power state transition capability is that reduced capability awake state can be switched to the awake state with full capabilities.

18. The method of claim 17, further comprising:
receiving, from the STA, while in the reduced capability awake state, a second message;
transitioning, before expiration of the scheduled time window, from the reduced capability awake state to the awake state with full capabilities; and
transmitting, to the STA, a third message, in response to the second message.

19. The method of claim 18, wherein the second message includes a presence request or an indication of latency sensitive data, and
wherein the third message includes an active frame indicating that the power save schedule is stopped.

20. An access point (AP), comprising:
a transceiver; and
a processor configured to:
transmit, to a station (STA), via the transceiver, a first message indicating a power save schedule of the AP, and
transition the AP, during a scheduled time window, from an awake state to a reduced power state, based on the power save schedule,
wherein the reduced power state is associated with a power state transition capability.
